(19) United States
(12) Patent Application Publication
(10) Pub. No.: US 2018/0041827 A1
(43) Pub. Date: Feb. 8, 2018

(54) HEADPHONE HOUSING ASSEMBLY

(71) Applicant: The Ketchum Group, Inc., dba, Outdoor Technology, Laguna Beach, CA (US)

(72) Inventor: Anthony Abdelmalek, Santa Monica, CA (US)

(73) Assignee: The Ketchum Group, Inc., dba, Outdoor Technology, Laguna Beach, CA (US)

(21) Appl. No.: 15/230,066

(22) Filed: Aug. 5, 2016

(51) Int. Cl. H04R 1/10

(52) U.S. Cl. CPC H04R 1/1066; H04R 1/1008; H04R 1/105; H04R 1/1033

(57) ABSTRACT

A headphone housing assembly for receiving a removable earpiece assembly, comprising two substantially annular ear cups and a headband assembly, the headband assembly comprising an inner headband and an outer headband that fit removably together to hold a speaker wire. The headband assembly has two ends, to which the ear cups are connected. The ear cups come apart to allow a pair of speakers to be removably inserted into the ear cups, with speaker wire running through the headband assembly.

### FIELD OF THE INVENTION

The present invention relates generally to headphones and, more particularly, to a headphone housing assembly into which speakers may be easily inserted and removed.

### BACKGROUND OF THE INVENTION

Headphones are popularly used to listen to music on the go. A wide variety of headphones are on the market, and they allow a user to listen to an audio source privately without broadcasting it to others. Typically, headphones are made up of two earpieces that fit over a user's ears, connected by a headband that holds the headphones in place. The earpieces are typically padded, and fitted with speakers and a transducer. The speakers are connected by speaker wire, which is generally built into the headband. The headband, speakers, and wires are typically built as one fixed piece. Most headphones connect to an audio source such as a smartphone with a cable inserted into an audio jack. Other headphones communicate with the audio source wirelessly via Bluetooth® technology.

Ear buds are another device for privately listening to an audio source. Ear buds fit into a user's ears, and are held in place in the ear rather than with a headband. However, headphones are known to be superior to ear buds in terms of audio quality and comfort.

It is desirable to listen to music while engaging in active pursuits, which may necessitate wearing a hat, helmet, or other headgear. This can be problematic in conjunction with headphones because of the bulky nature of traditional headphones. Most hats and helmets will not fit properly on top of headphones. To solve this problem, there are products that provide speakers built into a hat or helmet. But, a good set of speakers can be costly. Thus, it is preferable to have one set of speakers that can be used with a variety of headgear.

To that end, products are available that provide modular speakers that can be inserted into hats, helmets, loudspeakers, and so forth. For instance, U.S. Pat. No. 9,925,806 to Krissman et al. is herein incorporated by reference. The headphone assembly of the '806 patent includes two earpieces coupled by a flexible connecting wire, and is mountable within separate headwear such as protective helmets, ski caps, earmuffs, headbands, and so forth.

Another shortfall of the headphones currently available is that the speakers cannot be replaced easily. Generally, replacing the speakers in a set of headphones requires hiring a professional. This often makes it more cost-effective to buy a whole new set of headphones, which is wasteful. A user may seek to replace the speakers in their headphones if they degrade, if speaker technology improves, or if the user wishes to upgrade to more powerful speakers.

The present invention solves these needs and others, by providing a headphone housing assembly that removably houses a pair of speakers. The headphone assembly snaps open and closed, allowing speakers and wiring to be inserted or removed with ease.

### SUMMARY OF THE INVENTION

Briefly, and in general terms, by example and not limitation, the invention provides a headphone assembly for receiving a removable earpiece assembly (i.e., removable speakers). The headphone assembly is suited to receive a removable earpiece assembly comprising two earpieces connected by a flexible wire (i.e., speaker wire). The headphone assembly comprises a headband assembly and two substantially annular ear cups disposed at the ends of the headband assembly. The headband assembly is sized to extend over the head of a user, and comprises an inner headband and an outer headband, which fit together in a removable manner so that the wire of the earpiece assembly can be inserted and removed into the headband assembly. Each ear cup has an annular opening configured to hold an earpiece in a removable manner. Thus, the earpiece assembly can be inserted or removed into the headphone assembly so that the earpieces are housed in the ear cups and the wire is enclosed within the headband assembly.

In a detailed aspect of an exemplary embodiment in accordance with the invention, the headband assembly comprises an outer headband, an inner headband, and a frame. The inner and outer headbands are removable to allow speaker wire to be threaded through the frame.

In another detailed aspect of an exemplary embodiment in accordance with the invention, a hinge assembly is provided to clip the ear cups to the headband assembly. The hinge assembly clips open to allow the headband pieces to be disassembled. When the headband assembly is reassembled, the hinge assembly clips shut, holding the headphone assembly together in one piece.

More specifically, in an exemplary embodiment in accordance with the invention, the headband further comprises a head pad and ear pads attached to the inner surface of each ear cup. The pads are made of a soft material for a comfortable fit.

In another detailed aspect of an exemplary embodiment in accordance with the invention, the interior wall of each of the ear cups is composed of a plurality of planar segments, defining a polygonal opening. The polygonal opening is sized and shaped so that a speaker fits in the center of each ear cup in a snap-fit arrangement. The ear cups are fitted with teeth that hold the speakers in place, and attachment members to facilitate attachment of the ear cups to the headband assembly.

It is accordingly an object of the present invention to provide a headphone assembly that removably houses a removable earpiece assembly.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a perspective view of a headphone housing assembly in accordance with the present invention.

FIG. 2 is a top perspective view of the headphone assembly of FIG. 1.

FIG. 3 is a front perspective view of the headphone assembly of FIG. 1.

FIG. 4 is a side perspective view of the headphone assembly of FIG. 1.

FIG. 5 is exploded view of the headphone assembly of FIG. 1.

FIG. 6 is a front exploded view of the headphone assembly of FIG. 1.

FIG. 7 is a side exploded view of the headphone assembly of FIG. 1.

FIG. 8A is front perspective view of an ear cup of the present invention, depicting the inner surface of the ear cup with a speaker partially inserted therein.

FIG. 8B is front perspective view of an ear cup of the present invention, depicting the inner surface of the ear cup with a speaker fully inserted therein.

FIG. 9 is a side view of the headphone assembly of FIG. 1, with the outer headband removed, depicting a speaker wire running from the speaker into the frame.

FIG. 10 is a view of a removable earpiece assembly, which the headphone assembly of FIGS. 1-9 is configured to receive.

### DETAILED DESCRIPTION OF THE PREFERRED EMBODIMENTS

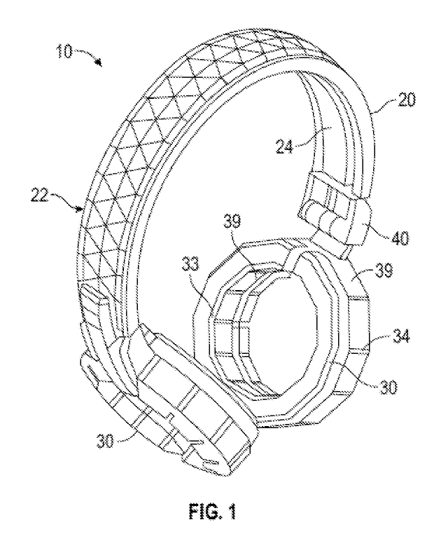

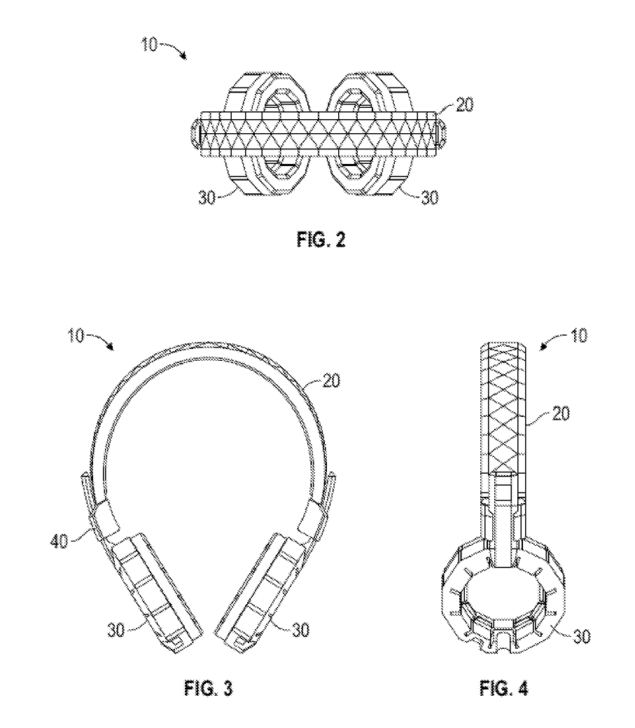

With reference now to the drawings, and particularly FIGS. 1-4, there is shown a headphone assembly 10 for receiving a removable earpiece assembly comprising a headband assembly 20, ear cups 30, and a hinge assembly 40 for connecting the two.

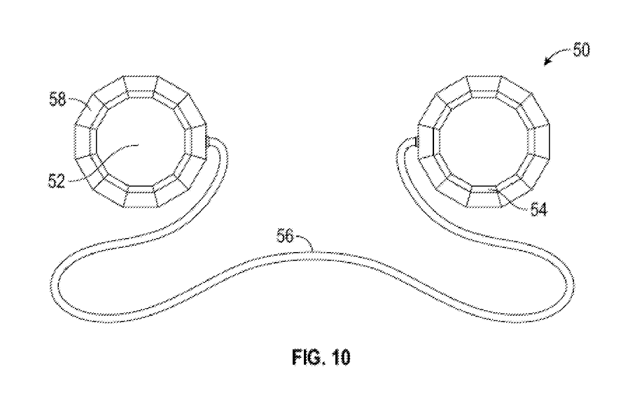

FIG. 10 shows an exemplary removable earpiece assembly 50, which the present invention is configured to receive. The removable earpiece assembly has a first earpiece 52, a second earpiece 54, and a flexible wire 56 connecting the two. In a preferred embodiment, the earpieces 52, 54 have perimeters defined by a plurality of planar segments 58. Preferably, each earpiece contains a Bluetooth®-enabled speaker in wireless communication with a device for playing audio. The earpieces may also be speakers that communicate with a device with a cable connection.

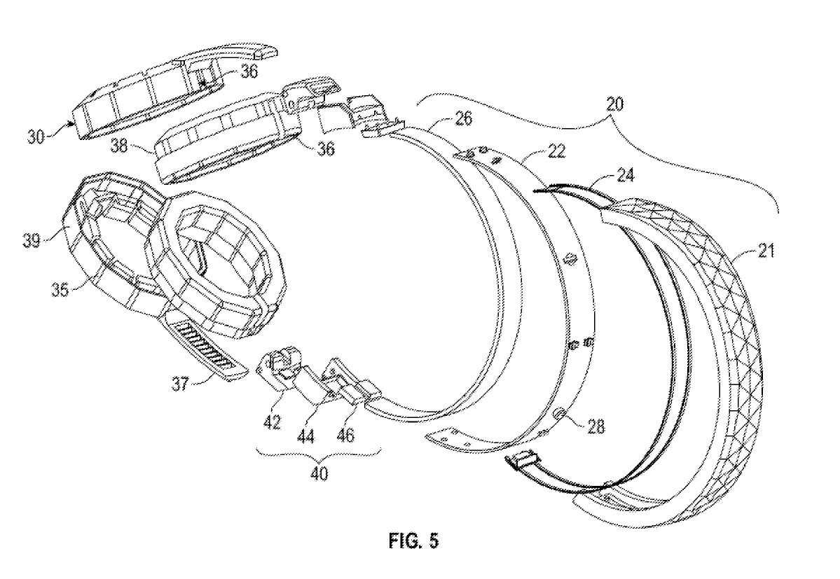

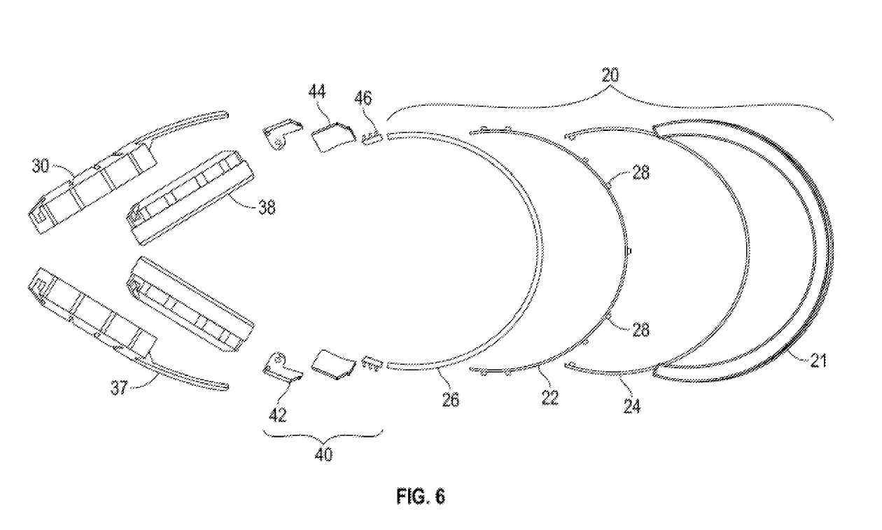

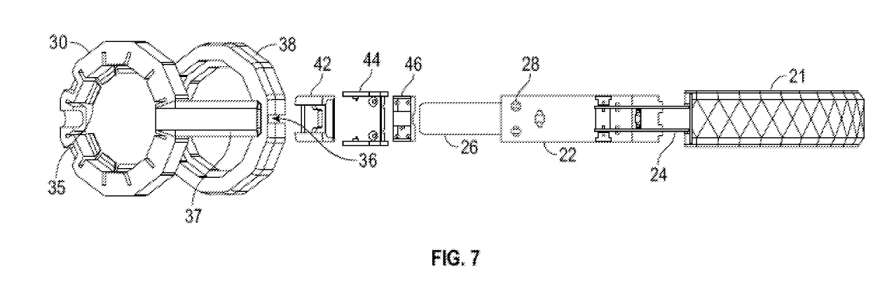

Referring now to FIGS. 5-7, the headband assembly 20 comprises an outer headband 21, an inner headband 22, and a frame 24. The inner headband 22 provides a plurality of clips 28 to removably attach the inner headband 22 to the frame 24. As shown in FIG. 5, the frame 24 comprises two thin bands of material terminating in an attachment means at each end, by means of which it may be attached to the ear cups 30 via the hinge assembly 40. The frame 24 is preferably composed of metal, such as steel. The inner headband 22 and clips 28 are preferably formed from a single piece of plastic, such as polyethylene.

Other configurations are also possible, but the key aspect of the headband assembly 20 is that it can accommodate the insertion of speaker wire, keeping it out of the way. For example, in another embodiment, the headband assembly includes an inner headband and an outer headband which fit together to house the wire without the need for a frame. The headband could also be a single piece configured to hold a flexible wire in place. In any case, when the invention is used, as preferred, with two Bluetooth®-enabled speakers connected by a flexible wire, the invention provides headphones with no loose wiring, which is ideal for the active user.

The outer headband 21 is flexible, so as to be removably attachable over the inner headband 22 and frame 24. The outer headband 21 is preferably made of silicone, which is flexible and durable. The pliable nature of silicone allows the outer headband to easily be fitted onto the inner headband and frame. The outer headband may, however, be made of any material desired, such as plastic or metal. The headband assembly may further provide a head pad 26 for a more comfortable fit. The head pad 26 is composed of ethylene-vinyl acetate (EVA), or similar material.

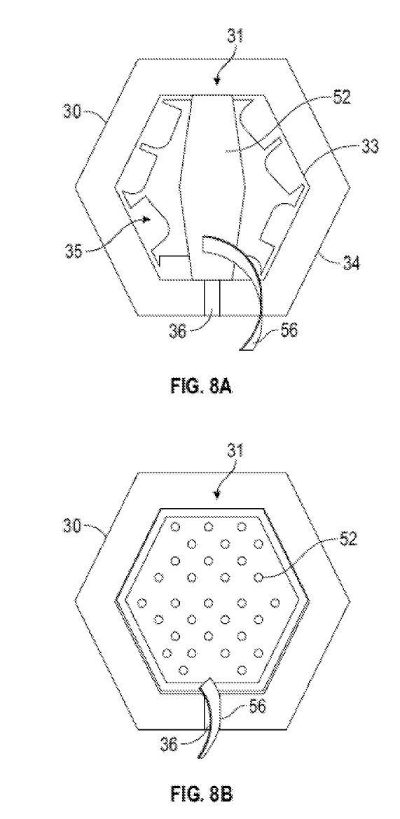

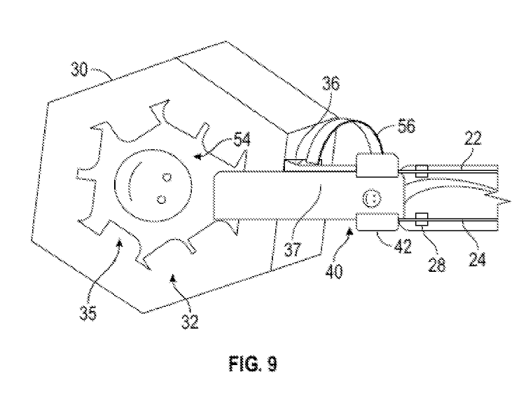

FIGS. 8A-9 show the headphone assembly 10 with speakers inserted therein. The ear cups 30 are substantially annular in shape, each forming an opening sized to accommodate an earpiece 52, 54. The ear cups 30 further provide teeth 35 to hold the earpieces 52, 54 in place, an attachment member 37 to facilitate clipping the ear cups 30 to the hinge assembly 40 and headband assembly 20, and a channel 36 through which to feed speaker wire 56. The teeth 35 are disposed proximate to the interior wall 33 of the outer surface 32 of the ear cups 30, and permit speakers 53, 54 to be secured in the openings of the ear cups in a snap fit. The ear cups 30, teeth 35, attachment member 37, and channel 36 are preferably composed of a single piece of plastic such as ABS. Referring now to FIGS. 5-7, each ear cup 30 is fitted with an ear pad 38 for comfort, which may be composed of polyurethane or similar material.

Each ear cup 30 includes an interior wall 33 forming the opening and having teeth 35 disposed thereabout. In the exemplary embodiment, the interior wall 33 comprises a plurality of planar segments 39 (shown in FIG. 1), which forms a polygonal opening. The outer wall 34 of each ear cup also includes a plurality of planar segments 39, which in the exemplary embodiment forms a polygonal shape. The ear cups 30 are preferably fitted with a plurality of teeth 35 to accommodate the insertion of an earpiece 52, 54.

Referring now to FIGS. 5-7, the hinge assembly 40 comprises an ear cup hinge 42, a hinge bracket 44, and a frame cover 46. The frame cover 46 is attached to the end of the frame 24. The ear cup hinge 42 clips open and shut. When the ear cup hinge 42 is in an open position, the inner headband 22 and outer headband 21 may be detached from the ear cups 30. Once the inner and outer headbands 21, 22 are reattached, such as after the insertion of earpieces 52, 54, the ear cup hinge 42 clips down, holding the headphone assembly 10 together.

To insert a removable earpiece assembly 50 into the headphone housing assembly 10, a user unclips the hinge assembly 40, then removes the outer headband 21 and inner headband 22 from the frame 24. As shown in FIG. 8A, an earpiece 52, 54 is first inserted into the inner surface 31 of an ear cup so that it is transverse to the body of the ear cup 30. The earpiece 52, 54 so fits through the ear cup 30 when inserted directly above the channel 36. The user then pulls the earpiece 52, 54 through the ear cup 30, so that it extends from the outer surface of the ear cup 32. As shown in FIG. 8B, the user then rotates the earpiece 52, 54 so that it is parallel to the body of the ear cup 30, and which point the earpiece 52, 54 clicks in to fit securely in the ear cup 30, held snug by the teeth 35.

The headphone housing assembly 10 is suited to accommodate two speakers 52, 54 connected by a speaker wire 56, such as CHIPS®—Universal Bluetooth Wireless Helmet Audio, manufactured by Outdoor Tech.

Referring now to FIG. 9, the wire 56 is guided to exit the ear cup 30 through channel 36. The wire 56 is then fed between the two bands comprising the frame 24. When the same process is applied to both earpieces 52, 54, the wire 56 will connect them while lying substantially parallel to the frame 24.

Next, the inner headband 22 is clipped on to the frame 24 with the clips 28. The outer headband 21 is then slipped over the inner headband 22, frame 24, and wire 56. Finally, the ear cup hinges 42 snap down, securing the headband assembly 20 together.

To remove the earpiece assembly 50, the process is accomplished in reverse—the hinge assemblies 40 are snapped open, and the outer headband 21 and inner headband 22 are detached from the frame 24. The earpieces 52, 54 may then be removed from the ear cups 30.

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed is:

1. A headphone assembly for receiving a removable earpiece assembly having a first earpiece and a second earpiece connected by a wire, said headphone assembly comprising:
a headband assembly sized to extend over the head of a user and terminating in two ends, said headband assembly comprising an inner headband and an outer headband, wherein said inner headband and outer headband fit removably together to house the wire of the removable earpiece assembly; and
two annular ear cups disposed at the ends of the headband assembly, said ear cups sized to receive the first and second earpieces of the removable earpiece assembly, respectively, in a removable manner.

2. The headphone assembly of claim 1, further comprising a frame, wherein the inner headband comprises a plurality of clips facilitating the removable attachment of the inner headband to the frame.

3. The headphone assembly of claim 1, further comprising a hinge assembly for attaching said ear cups to said headband assembly.

4. The headphone assembly of claim 1, further comprising a head pad attached to the inner headband and ear pads attached to the inner surface of each ear cup.

5. The headphone assembly of claim 1, wherein the outer headband is made of silicone.

6. The headphone assembly of claim 1, wherein each of said ear cups further comprises a channel to accommodate speaker wire, and the interior wall of each of said ear cups comprises a plurality of planar segments.

7. The headphone assembly of claim 1, said ear cups further defining an annular opening, wherein a plurality of teeth are disposed about said annular opening for securing the earpieces in snap fit.

8. A headphone assembly for receiving a removable earpiece assembly having a first earpiece and a second earpiece connected by a wire, said headphone assembly comprising:
a headband assembly sized to extend over the head of a user and terminating in two ends; and
two substantially annular ear cups disposed at the ends of the headband assembly, said ear cups sized to receive the first and second earpieces of the removable earpiece assembly, respectively, in a removable manner, wherein:
the interior wall of each of said ear cups comprises a plurality of planar segments defining a polygonal opening; and
a plurality of teeth are disposed about the polygonal opening for securing the earpieces in snap fit.

9. The headphone assembly of claim 8, the headband assembly comprising an inner headband and an outer headband, wherein said inner headband and outer headband fit removably together to house the wire of the removable earpiece assembly.

10. The headphone assembly of claim 9, the headband assembly further comprising a frame, wherein the inner headband comprises a plurality of clips facilitating the removable attachment of the inner headband to the frame.

11. The headphone assembly of claim 8, further comprising a hinge assembly for attaching said ear cups to said headband assembly.

12. The headphone assembly of claim 8, further comprising a head pad attached to the inner headband and ear pads attached to the inner surface of each ear cup.

13. The headphone assembly of claim 8, wherein the outer headband is made of silicone.

14. The headphone assembly of claim 8, wherein said ear cups further comprise a channel to accommodate speaker wire.

15. A headphone assembly for receiving a removable earpiece assembly having a first earpiece and a second earpiece connected by a wire, said headphone assembly comprising:
a headband assembly sized to extend over the head of a user and terminating in two ends; and
two substantially annular ear cups disposed at the ends of the headband assembly, said ear cups sized to receive the first and second earpieces of the removable earpiece assembly, respectively, in a removable manner, wherein the interior wall of each of said ear cups comprises a plurality of planar segments.

16. The headphone assembly of claim 15, the headband assembly comprising an inner headband and an outer headband, wherein said inner headband and outer headband fit removably together to house the wire of the removable earpiece assembly.

17. The headphone assembly of claim 16, the headband assembly further comprising a frame, wherein the inner headband comprises a plurality of clips facilitating the removable attachment of the inner headband to the frame.

18. The headphone assembly of claim 15, further comprising a hinge assembly for attaching said ear cups to said headband assembly.

19. The headphone assembly of claim 15, said ear cups further defining an annular opening, wherein a plurality of teeth are disposed about said annular opening for securing the earpieces in snap fit.

20. The headphone assembly of claim 15, wherein said ear cups further comprise a channel to accommodate speaker wire.
